(19) United States
(12) Patent Application Publication
(10) Pub. No.: US 2013/0038672 A1
(43) Pub. Date: Feb. 14, 2013

(54) IMAGE FORMING APPARATUS, AND LIGHT BEAM POWER ADJUSTING METHOD AND PROGRAM

(71) Applicant: Yutaka OHMIYA, Tokyo (JP)

(72) Inventor: Yutaka OHMIYA, Tokyo (JP)

(21) Appl. No.: 13/562,699

(22) Filed: Jul. 31, 2012

(30) Foreign Application Priority Data
Aug. 9, 2011 (JP) 2011-173894

(51) Int. Cl. B41J 2/435

(52) U.S. Cl. 347/246

(57) ABSTRACT

An image forming apparatus to form an image by optical scanning includes a light emitter to emit a light beam; a rotary reflective mirror to reflect the light beam; a photoreceptor to receive the light beam reflected by the rotary reflective mirror to form a latent image; a light sensor to detect the light beam; and an optical scanning controller to control scanning of the light beam. In such an image forming apparatus, the optical scanning controller causes the light emitter to emit the light beam when the light beam does not expose an area of the photoreceptor where a latent image is formed and adjusts a power of the light beam in discrete increments to a predetermined level appropriate for optical scanning.

### CROSS-REFERENCE TO RELATED APPLICATION

The present application claims priority from Japanese patent application number 2011-173894, filed on Aug. 9, 2011, the entire contents of which are incorporated by reference herein.

### BACKGROUND OF THE INVENTION

1. Field of the Invention

The present invention relates to an image forming apparatus to form an image by optical scanning, and in particular relates to an image forming apparatus adjusting power for the optical scanning, light beam power adjusting method and a program thereof.

2. Description of the Related Art

Conventionally, in an image forming apparatus such as a laser printer or a digital copier, a latent image is formed by directing a laser beam onto a photoreceptor to form an image for printing. In such an image forming apparatus, before performing such optical scanning, the power of the light beam power is adjusted to a level appropriate for scanning.

In the light beam power adjustment process, the laser beam is actually emitted, its power is detected by a sensor, and the current needed to obtain the requisite power for scanning is calculated. Therefore, the laser beam must be actually emitted to obtain the laser beam with a suitable power for scanning, thereby optically degrading the photoreceptor due to irradiation by the laser beam irradiation.

With this regard, JP-2008-096936-A discloses an image forming apparatus capable of calculating proper amount of current value using a weaker laser diode beam during scanning than during actual image formation, considering the optical degradation of the photoreceptor drum and the calculation precision of the current value.

However, even though the image forming apparatus disclosed in JP 2008-096936-A employs a weaker beam for power adjustment than for actual image formation, because the photoreceptor drum is still exposed, the optical degradation of the photoreceptor drum does occur and the photoreceptor drum is degraded prematurely.

The above image forming apparatus additionally includes a mechanical shutter to shield the laser beam so that the exposure of the photoreceptor in the power adjustment can be prevented. However, the mechanical shutter and a further additional mechanism such as a motor to control the mechanical shutter need to be provided.

### BRIEF SUMMARY OF THE INVENTION

The present invention provides an image forming apparatus capable of adjusting the power of the laser beam without degrading the photoreceptor during exposure by the laser beam, and a power adjusting method and a program allowing the apparatus to perform the power adjusting method.

More specifically, the image forming apparatus of the present invention emits a light beam determining a timing in which the light beam does not expose an area of the photoreceptor where a latent image is formed thereon and adjusts the power to increase until the power of the light beam becomes an appropriate power for the optical scanning. With this structure, the image forming apparatus of the present invention can adjust the power without degrading the photoreceptor due to optical scanning. According to the light beam power adjusting method and program of the present invention, the light beam is emitted when the light beam does not expose an area of the photoreceptor where a latent image is formed thereon and the power is so adjusted to be increased until the power of the light beam becomes an appropriate power for the optical scanning.

These and other objects, features, and advantages of the present invention will become more readily apparent upon consideration of the following description of the preferred embodiments of the present invention when taken in conjunction with the accompanying drawings.

### BRIEF DESCRIPTION OF THE DRAWINGS

FIG. 1 is a view illustrating a structure of an image forming apparatus according to an embodiment of the present invention;

FIG. 2 is a view illustrating a functional structure of an optical scanning controller included in the image forming apparatus in FIG. 1;

FIG. 3 is a timing chart for scanning by the image forming apparatus according to the embodiment; and

FIG. 4 is a flowchart of a power adjustment operation performed by the image forming apparatus according to the embodiment.

### DETAILED DESCRIPTION OF THE INVENTION

A description is now given of embodiments of the present invention.

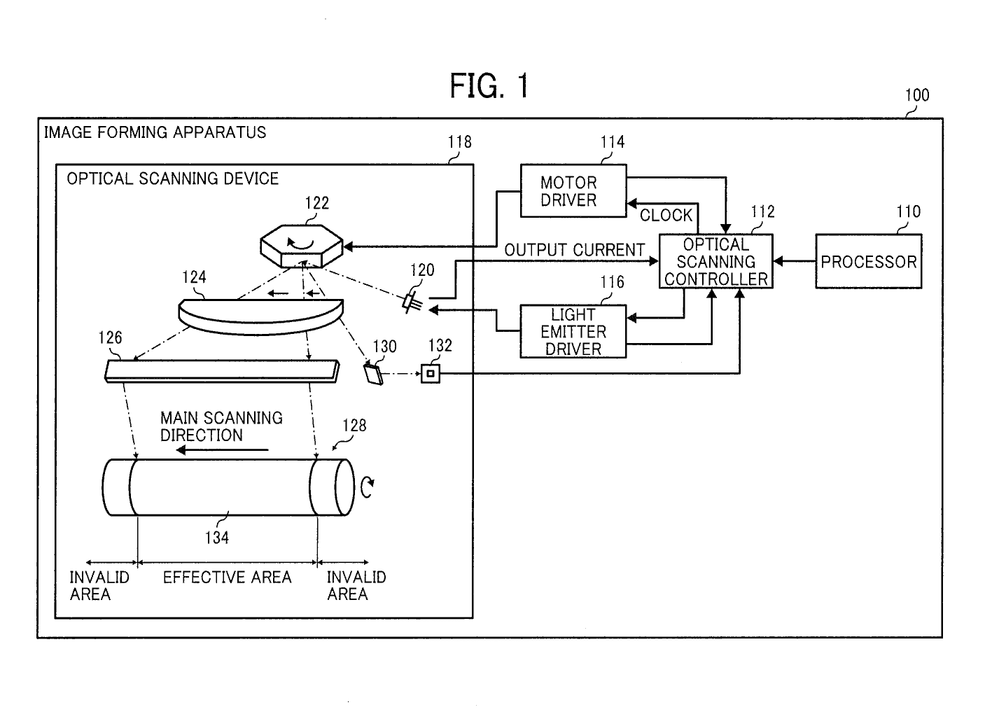

FIG. 1 is a view illustrating a structure of an image forming apparatus according to an embodiment of the present invention. An image forming apparatus 100 includes a processor 110, an optical scanning controller 112, a motor driver 114, a light emitter driver 116, and an optical scanner 118.

The processor 110 is a processor such as a CPU or MPU that controls the entire image forming apparatus 100. The processor 110 supplies to-be-printed image data to the optical scanning controller 112 to cause the optical scanner 118 to form a latent image of the image data. In addition, the processor 110 causes the optical scanning controller 112 to control emitted power of the optical scanner 118 when the apparatus recovers from a standby mode in which power consumption is reduced or when the power is initially turned on.

The optical scanning controller 112 controls the optical scanner 118. The optical scanning controller 112 controls light radiated from the optical scanner 118 by using the light emitter driver 116, and controls rotation of a rotary reflective mirror 122 included in the optical scanner 118 using the motor driver 114.

The optical scanning controller 112 performs a power adjustment process to adjust the power when the image forming apparatus 100 is initially turned on or when the image forming apparatus 100 recovers from a standby mode, so that the optical scanner 118 can form a latent image with an adjusted power suitable for latent image formation. In the printing process, the optical scanning controller 112 causes the light emitter driver 116 to control a timing of the radiation of the light beam radiation by the optical scanner 118, and causes the optical scanner 118 to form a latent image of the to-be-printed image data received from the processor 110.

The optical scanning controller 112 supplies a signal to instruct light emission timing of the optical scanner 118 (hereinafter referred to as a light source signal) and current data, which is a current value that determines the power of the light beam that the optical scanner 118 radiates, to the light emitter driver 116, and controls light emission timing and emitted light of the optical scanner 118. In the present embodiment, the optical scanning controller 112 can be implemented as a semiconductor device such as an ASIC having the control capability described above.

The motor driver 114 controls rotation of a rotary reflective mirror 122 of the optical scanner 118. The motor driver 114 causes a drive motor, not shown, to rotate or stop in synchrony with a clock signal generated by the optical scanning controller 112, thereby controlling the operation of the rotary reflective mirror 122 attached to the drive motor. The drive motor includes a magnet and a coil. When the motor driver 114 supplies an alternating current with different phases to the drive motor, a repulsive force and an attractive force are alternately generated between the magnet and coil so that the drive motor rotates. In the present embodiment, the motor driver 114 can be implemented as a semiconductor device such as an ASIC having the controlling function described above.

The light emitter driver 116 controls a light emitter 120 of the optical scanner 118. The light emitter driver 116 causes the light emitter 120 to emit light by the current data designated by the optical scanning controller 112 in synchrony with a light source signal. In the present embodiment, the light emitter driver 116 can be implemented as a semiconductor device such as an ASIC having the controlling function described above.

The optical scanner 118 forms an image by the optical scanning and includes the rotary reflective mirror 122, a lens 124, a reflective mirror 126, and the photoreceptor 128.

The light emitter driver 120 serves as a light emitting means to irradiate light beams under control of the light emitter driver 116. The light beam that the light emitter 120 emits is directed onto the rotary reflective mirror 122. In the present embodiment, as the light emitter 120, a laser diode including a photo diode as a light detection means is used. The photo diode receives a light beam emitted by the laser diode and supplies output current corresponding to the power of the light beam to the optical scanning controller 112.

The rotary reflective mirror 122 is a deflection means to deflect the light beam emitted by the light emitter 120 in a main scanning direction. A drive motor, not shown, is attached to the rotary reflective mirror 122. When the drive motor rotates under control of the motor driver 114, the rotary reflective mirror 122 rotates so that the light beam is reflected from each side in the main scanning direction. In the embodiment illustrated in FIG. 1 the rotary reflective mirror 122 is embodied as a polygonal mirror, but a rotary mirror with any other suitable polygonal shape can be used.

The lens 124 collects optical beams reflected by the rotary reflective mirror 122 and directs the reflected optical beams onto the photoreceptor 128 at a constant speed. The light beam reflected by the rotary reflective mirror 122 is directed onto the reflective mirror 126 via the lens 124 and exposes the photoreceptor 128. In the present embodiment, the lens 124 is embodied by a lens such as an fθ lens. The reflective mirror 126 reflects the light beam collected by the lens 124. The reflective mirror 126 reflects the light beam and radiates the reflected light beam to the photoreceptor 128.

The photoreceptor 128 is an image carrier on which a latent image is formed by the light beam of the light emitter 120. When printing is performed, the photoreceptor 128 is charged by a charging device such as a corona charger and is exposed by the light beam of the light emitter 120 to form an electrostatic latent image on the photoreceptor 128 such that the to-be-printed parts of the image data retain the charge. Then, toner is deposited on the photoreceptor 128, a recording sheet is pressed against the photoreceptor 128, and the toner is transferred to the recording sheet to form a finished printed product.

An irradiation area of the light beam of the light emitter 120 includes an effective area and an invalid area. The electrostatic latent image is formed on the effective area 134 of the photoreceptor 128. The invalid area is an area other than the effective area among the irradiation areas of the light beam of the light emitter 120.

The optical scanner 118 includes a reflective mirror 130 and a light sensor 132. The reflective mirror 130 is a reflection means to reflect the light beam reflected by the rotary reflective mirror 122 and direct the reflected light beam onto the light sensor 132.

The light emitter driver 132 serves as a light sensing means to detect a light beam of the light emitter 120.

The light sensor 132 that has received the light beam deflected by the rotary reflective mirror 122 supplies an output current corresponding to the power of the input light beam to the optical scanning controller 112. When the rotary reflective mirror 122 rotates, the light sensor 132 receives periodically the light beam. The optical scanning controller 112 when detecting the output current supplied by the light sensor 132 detects that the light beams are irradiated to the light sensor 132.

It should be noted that, in the present embodiment, the power of the light beam configured to expose the photoreceptor 128 is obtained from the output current of the light emitter 120. Alternatively, however, the power of the light beam can be detected by using the output current of the light sensor 132.

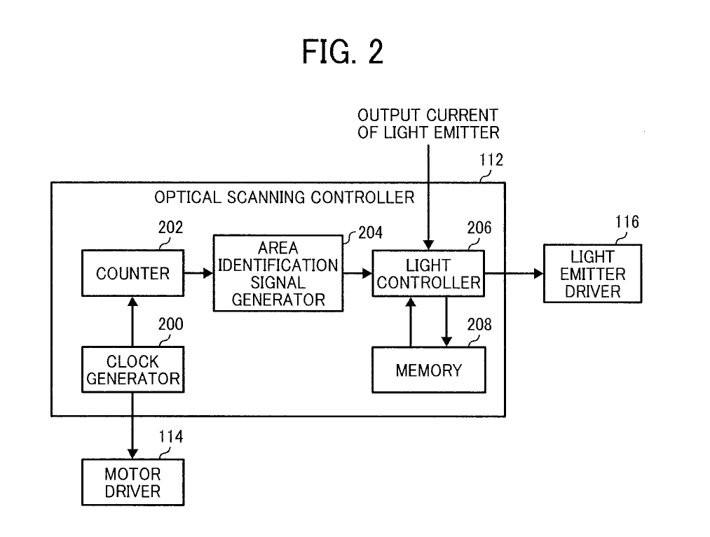

Next, an outline of the optical scanning controller 112 will now be described with reference to FIG. 2. FIG. 2 is a view illustrating a functional structure of an optical scanning controller included in the image forming apparatus of FIG. 1.

The optical scanning controller 112 includes a clock generator 200, a counter 202, an area identification signal generator 204, a light controller 206, and a memory 208.

The clock generator 200 generates a clock signal to control rotation of the rotary reflective mirror 122. The clock generator 200 supplies the clock signal to the motor driver 114 to cause the drive motor to rotate in synchrony with the generated clock signal and synchronize rotation of the rotary reflective mirror 122 with the clock.

The counter 202 counts the clock generated by the clock generator 200. The counter 202 counts the clock upon detecting a rise of the clock generated by the clock generator 200. The counter 202 holds a number of clocks counted when power to the image forming apparatus 100 is turned on, and resets the number of clocks when the power is interrupted or moved to a power-saving mode.

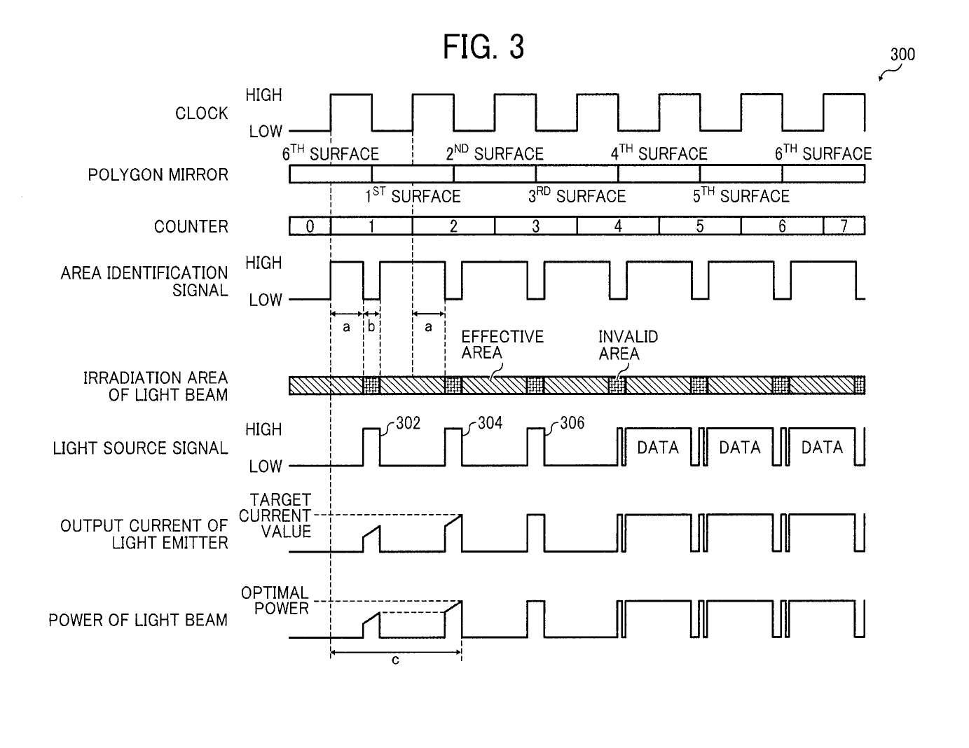

The area identification signal generator 204 generates an area identification signal that distinguishes between the effective area and the invalid area. The area identification signal generator 204 observes the counter 202, generates the area identification signal using the number held in the counter 202, and supplies the area identification signal to the light controller 206. In the present embodiment, the area identification signal generator 204 outputs an area identification signal with a high level as an effective area and the area identification signal with a low level as an invalid area (see FIG. 3, described in detail below).

The optical scanning controller 206 controls the optical scanning. The light controller 206 determines a proper timing with which the light beams expose the effective area of the photoreceptor based on the area identification signal and, when the light beams do not expose the effective area of the photoreceptor, causes, via the light emitter driver 116, the light emitter 120 to radiate the light beam. Specifically, the light controller 206 reads current data stored in the memory 208 and, when the irradiation area of the light beam is an invalid area, causes the light beam to be emitted with a power designated by the current data. Then, the light controller 206 adjusts the power to increase stepwise so that the power of the light beam becomes optimal for the optical scanning.

The light controller 206 can determine the power of the light beam based on the value of the output current that the light emitter 120 supplies. When the output current reaches a target current value of a level capable of radiating a light beam with a power suitable for the optical scanning, the light controller 206 stops irradiation of the light beam and terminates an adjusting process of the power.

When forming a latent image of the to-be-printed image on the photoreceptor, the light controller 206 supplies the light source signal to the light emitter driver 116 in synchrony with the output current being the synchronous signal supplied from the light sensor 132, and exposes the photoreceptor 128 with the light beam having the power obtained by the adjusting process of the power of the light beam.

FIG. 3 is a timing chart for scanning by the image forming apparatus according to the present embodiment. Referring to FIG. 3, a scanning timing of the light beam will now be described.

In the embodiment as illustrated in FIG. 3, an irradiation cycle of the light beam toward a first side surface of the polygonal mirror is synchronized with the clock cycle that the optical scanning controller 112 generates. As another embodiment, an irradiation cycle of the light beam toward the first side surface of the rotary reflective mirror having m number of sides may be configured to be synchronous with an nth clock cycle. Herein, m and n are integers and n/m is also limited to an integer.

The clock generator 200 of the optical scanning controller 112 supplies the clock signal to the motor driver 114, so that the polygonal mirror rotates in synchrony with the clock signal. The area identification signal generator 204 observes the value that the counter 202 counts and, when the clock generator 200 generates a clock and the counter value changes from “0” to “1”, generates the high area identification signal indicating that the irradiation area of the light beam is an effective area. The area identification signal generator 204 supplies the High-level area identification signal for a time “a” until the irradiation area of the light beam switches to the invalid area.

The area identification signal generator 204 generates an area identification signal of Low level indicating that the irradiation area of the light beam is an invalid area and supplies the Low-level area identification signal for a time “b” until the irradiation area of the light beam switches to the effective area. When the time “b” lapses, the area identification signal generator 204 again supplies the High-level area identification signal. The time periods “a” and “b” are defined by optical design values such as a rotation speed and a number of sides of the rotary reflective mirror 122 and a width of the photoreceptor 128.

The area identification signal generator 204 again generates and supplies the high area identification signal indicating that the irradiation area of the light beam is an effective area, upon the counter value changing from “1” to “2”. The area identification signal generator 204 repeats the above processes until the light beam power adjustment process terminates.

In the present embodiment, because the irradiation time of the light beam toward each side of the polygon mirror is synchronized with one cycle of the clock signal, all the time at which the counter number switches is used as a reference time and the area identification signal, either high or low, is generated. In the embodiment in which the irradiation time of the light beam toward each side of the polygon minor is synchronized with a time multiplied by an integer of the clock cycle, the area identification signal is generated at a reference time when the counter value becomes a predetermined number. For example, when the clock cycle in the embodiment as illustrated in FIG. 3 becomes half, the area identification signal generator 204 generates an area identification signal based on the timing when the counter value changes to a predetermined number such as “1”, “3”, and “5”.

In adjusting the power of the light beam of the image forming apparatus 100, the light controller 206 supplies the light source signals 302 and 304 to the light emitter driver 116 while the Low-level area identification signal is supplied, so as to cause the light emitter 120 to irradiate a light beam. By receiving the light beam, the light controller 206 receives an output current that the light emitter 120 generates, and by comparing the optimal power of the light beam most suitable for the optical scanning with the target current value of the irradiation-possible power of the light beam, determines whether the power of the light beam is optimal or not. The light controller 206 repeats the above processes until the power of the light beam becomes optimal.

In the embodiment as illustrated in FIG. 3, in a time period “c” from when the optical scanning controller 112 generates a clock of High Level to supply the light source signal 304 to the light emitter driver 116, an optimal power for the optical scanning can be obtained, thereby terminating the adjusting process of the power of the light beam. Thereafter, the optical scanning controller 112 supplies a light source signal 306 to the light emitter driver 116 so as to obtain a synchronization signal to be used for the image formation. Then, the optical scanning controller 112 causes the light emitter to radiate light beams to form a latent image in sync with the synchronization signal to the light emitter 120.

The present invention as illustrated in FIG. 3 obtains a light beam of optimal power by adjusting the power while the light beam is exposing the invalid area, thereby preventing the photoreceptor from deteriorating due to the power adjustment operation.

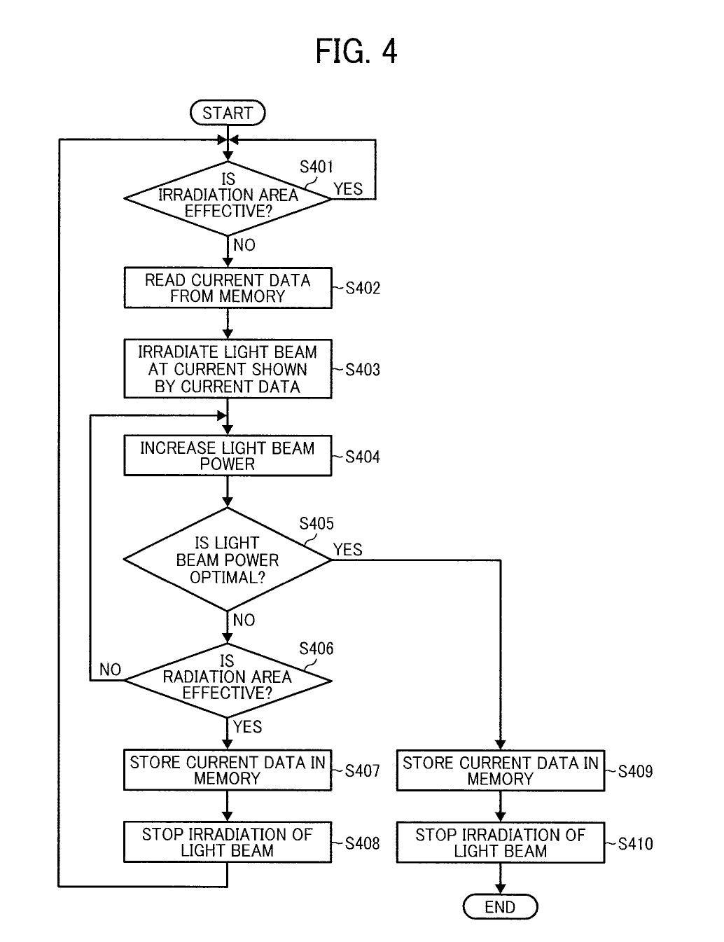

FIG. 4 is a flowchart illustrating a power adjustment operation performed by the image forming apparatus according to the present embodiment. Referring to FIG. 4, the power adjustment process to be performed when the image forming apparatus 100 is turned on or recovering from the power saving mode will now be described. FIG. 4 shows a process performed by the light controller 206 of the optical scanning controller 112 of the image forming apparatus 100, and the clock generator 200 and the area identification signal generator 204 generate a clock and an area identification signal while performing the power adjustment process in parallel.

The process of FIG. 4 starts from step S400 and the light controller 206 determines whether the irradiation area of the light beam is an effective area or not using the area identification signal supplied by the area identification signal generator 204 in step 5401. When the radiation area of the light beam is the effective area (YES in S401), a process in step S401 is repeated. By contrast, when the radiation area of the light beam is the invalid area (NO in S401), the process proceeds to a branched step of S402.

In step S402, the light controller 206 reads current data from the memory 208. In Step S403, the light controller 206 irradiates light beams having the current as indicated by the current data to the light emitter 120 via the light emitter driver 116. In step S404, the light controller 206 increases the power of the light beam by adding the current to be supplied to the light emitter 120.

In step S405, the light controller 206 compares an output current of the light emitter 120 and a target current value, and determines whether or not the power of the light beam is optimal for the optical scanning. If the power of the light beam is not optimal for the optical scanning (NO in S405), the process proceeds to step S406. In step S406, the light controller 206 determines whether the irradiation area of the light beam is an effective area or not using the area identification signal supplied from the area identification signal generator 204.

If the irradiation area of the light beam is the invalid area (NO in S406), the process returns to the step S404 and the power of the light beam is increased while the light beam is not exposing the effective area of the photoreceptor. On the other hand, when the radiation area of the light beam is the effective area (YES in S406), the process proceeds to a branched step S407.

In step S407, the light controller 206 stores current data of the light beam emitted by the light emitter 120, in the memory 208. In step S408, the light controller 206 stops irradiation of the light beam by the light emitter 120 via the light emitter driver 116, the process returns to the step S401, and the aforementioned process is again performed.

If it is determined that the power of the light beam is optimal for the optical scanning (YES in S405), the process proceeds to a branched step S409. In step S409, the light controller 206 stores the current data of the light beam emitted by the light emitter 120 in the memory 208. In step S410, the light controller 206 stops irradiation of light beams by the light emitter 120 via the light emitter driver 116 and an entire process terminates in step S411.

Additional modifications and variations of the present invention are possible in light of the above teachings. It is therefore to be understood that, within the scope of the appended claims, the invention may be practiced other than as specifically described herein.

What is claimed is:

1. An image forming apparatus to form an image by optical scanning, comprising:
a light emitter to emit a light beam;
a rotary reflective minor to reflect the light beam;
a photoreceptor to receive the light beam reflected by the rotary reflective minor to form a latent image;
a light sensor to detect the light beam; and
an optical scanning controller to control scanning of the light beam,
wherein the optical scanning controller causes the light emitter to emit the light beam when the light beam does not expose an area of the photoreceptor where a latent image is formed and adjusts a power of the light beam to a predetermined level appropriate for optical scanning.

2. The image forming apparatus as claimed in claim 1, wherein the optical scanning controller adjusts the power of the light beam in discrete increments.

3. The image forming apparatus as claimed in claim 1, wherein the optical scanning controller:
generates an area identification signal to identify an area of the photoreceptor on which the latent image is formed using a clock synchronized with a rotation of the rotary reflective minor;
determines a timing that the light beam exposes the area of the photoreceptor using the area identification signal; and
causes the light emitter to irradiate the light beam on the photoreceptor.

4. A power adjusting method for an image forming apparatus comprising a light emitter to irradiate a light beam; a rotary reflective mirror to reflect the light beam; a photoreceptor to receive the light beam reflected by the rotary reflective mirror to form a latent image; a light sensor to detect the light beam; and an optical scanning controller to control scanning of the light beam, and configured to form an image by optical scanning,
the method comprising:
radiating the light beam when the light beam does not expose an area of the photoreceptor where a latent image is formed;
detecting the light beam; and
adjusting a power of the light beam in discrete increments until the detected power of the light beam achieves a predetermined level appropriate for optical scanning.

5. The power adjusting method as claimed in claim 4, comprising:
generating an area identification signal to identify an area of the photoreceptor on which the latent image is formed using a clock synchronized with a rotation of the rotary reflective mirror reflecting the light beam;
determining a timing with which the light beam exposes the area of the photoreceptor using the area identification signal; and
causing the light emitter to irradiate the photoreceptor with the light beam.

6. A non-transitory computer-readable storage medium storing a program that, when executed by a computer, causes the computer to execute a power adjusting method for an image forming apparatus comprising a light emitter to irradiate a light beam; a rotary reflective mirror to reflect the light beam; a photoreceptor to receive the light beam reflected by the rotary reflective mirror to form a latent image; a light sensor to detect the light beam; and an optical scanning controller to control scanning of the light beam, and configured to form an image by optical scanning,
the method comprising:
radiating the light beam when the light beam does not expose an area of the photoreceptor where a latent image is formed;
detecting the light beam; and
adjusting a power of the light beam in discrete increments until the detected power of the light beam achieves a predetermined level appropriate for optical scanning.
